(19) United States
(12) Patent Application Publication
(10) Pub. No.: US 2007/0259970 A1
(43) Pub. Date: Nov. 8, 2007

(54) Method for Dispersing and Passivating Particulate Powders in Water and Aqueous Media

(75) Inventors: Gottfried Boden, Dresden (DE); Sven Thiele, Freiberg (DE); Manfred Nebelung, Dresden (DE)

Correspondence Address: GREENBLUM & BERNSTEIN, P.L.C., 1950 ROLAND CLARKE PLACE, RESTON, VA, 20191, US

(73) Assignees: FRAUNHOFER-GESELLSCHAFT ZUR FOEDERUNG DER ANGEWAND TEN FORSCHUNG E .V., Munich (DE); G.U.S. BETEILIGUNGS GMBH, Schwalbach/Saar (DE); WOLFRAM BERGBAU – UND HUETTEN-GMBH NFG. KG, St. Martin i.S. (AT); H.C. STARCK GMBH, Goslar (DE); KENNAMETAL GMBH & CO. KG, WERKZEUGE + HARTSTOFFE, Fuerth (DE); KENNAMETAL WIDIA GMBH & CO. KG, Essen (DE); GUEHRING OHG, Albstadt (DE); HARTMETALL AG, Hitzkirch (CH); CERATIZIT S.A., Mamer (LU)

(21) Appl. No.: 11/568,374

(22) PCT Filed: Apr. 13, 2005
(86) PCT No.: PCT/EP05/03886

§ 371 Date: Jan. 16, 2007

(30) Foreign Application Priority Data
Apr. 27, 2004 (DE) 10 2004 020 559.0

(51) Int. Cl. B01F 17/00

(52) U.S. Cl. 516/198

(57) ABSTRACT

The invention relates to a method for dispersing and passivating particulate powders in water and aqueous media. It is particularly advantageously applicable in the handling and processing of non-oxidic powders, e.g., in the ceramic and hard-metal industry. In the method claimed auxiliaries are added due to the process. According to the invention this method is characterized in that polyvinylamines and/or the initial products thereof are used as these auxiliaries.

The invention relates to a method for dispersing and passivating particulate hard-metal powders, ceramic powders and elemental powders of the 3^{rd} and 4^{th} main group of the Periodic Table of the Elements in water and aqueous media.

The invention is particularly applicable in the powder-processing industry (ceramics, hard-metal industry).

Today the production of molded articles from hard metals and ceramics is mainly carried out via the powder technology process, in which the initial powders together with additives are mixed in a liquid and optionally ground, and subsequently the powder mixture is dried, pressed into molds and sintered. While with silicate ceramics and oxide ceramics water is chiefly used thereby as a grinding and mixing liquid (dispersing agent, suspending agent), non-oxidic powders, such as hard-metal powders, nitride and carbide powders are processed in nonaqueous dispersing agents in order to repress or suppress oxidation and hydrolysis phenomena of the powder. Aliphatic and aromatic hydrocarbons, alcohols and acetone are used as nonaqueous liquids for this. Since for reasons of technical safety and industrial safety and environmental protection the processing of particulate powders in these organic liquids is relatively complex and cost-intensive (explosion-proof installations and buildings, solvent recovery, recycling processes), attempts have been made to carry out a dispersing of the powders in water or aqueous media with the addition of special auxiliaries.

EP 1153652 describes a method for dispersing mixtures of tungsten carbide and cobalt powders (hard-metal powder mixture) in part with the addition of further hard materials, such as TiC, TaC, TiN, (W,Ti)C, in aqueous or ethanol media with the addition of the cationic polyelectrolyte polyethylene imine. Through the addition of 0.1 to 10% by weight, preferably 0.1-1% by weight, of polyethylene imine with a molar weight of 5000 to 50,000, preferably 10000 to 30,000 g/Mol a good dispersion of the hard-metal powder mixture in water is thereby achieved and a viscosity is regulated that is suitable for a subsequent spray-drying process, e.g., 8-20 mPas with a shearing rate of 10-100 s⁻¹. Aqueous-ethanol hard-metal suspensions of WC-Co powder mixtures suitable for a spray drying can also be realized according to WO 98/00256 by the addition of 0.01 to 10% by weight, preferably 0.1-5% by weight dispersing agent such as polyacrylates, hydroxyethylcellulose, styrene maleic acid copolymers and ethylene oxide urethane copolymers. However, an increase in the oxygen content of the dried powder ought to be associated therewith. However, this is not described in the publication.

In WO 93/21127 surface-modified nanoscalar ceramic powders are produced, such as, e.g., Si₃N₄, SiC, Al₂O₃ and ZrO₂ by dispersing the respective unmodified powder in water and/or organic solvents such as alcohols by means of a low-molecular (molar weight up to 500 g/Mol) organic compound and subsequently removing the suspending agent. Carboxylic acids, amines, β-dicarbonyl compounds and organo-alkoxysilanes, for example, act as organic compounds (auxiliaries). In DE 4336694 the auxiliaries for dispersing the ceramic powders are expanded to low-molecular organic substances with a molar weight of up to 1000 g/Mol.

EP 0771316 describes the dispersion of nanoscalar non-oxidic powders such as TiN, TiC, Si₃N₄ and SiC in organic suspending agents with the object of producing sinterable green bodies, whereby polymolecular substances are used as dispersing agent, which substances comprise one or more polar groups and one or more long-chain aliphatic radicals, such as, e.g., alkyl-substituted imides of dicarboxylic acids.

DE 19751355 describes a method for dispersing particulate inorganic powders in preferably water or aqueous media, in which substances having a biological genesis, such as, e.g., sugar, starch and/or chitin derivatives are used as a dispersing agent. Dispersions with long-term stability are thereby produced in particular in aqueous media.

Moreover, DE 19800310 describes a solution in which non-oxidic ceramics are coated with amino acids of aqueous or organic solutions. Furthermore, DE 10130161 claims a method for conditioning non-oxidic very fine powders such as titanium nitride or silicon carbon nitride, in which the coating of the powders with a surfactant auxiliary that contains nitrogen in the polar head group, takes place in an organic solvent in a first step and subsequently in a second step the coated non-oxidic very fine powder is further processed in water or in air, whereby the oxygen content of the very fine powders does not increase or increases only slightly.

The disadvantage of the cited methods according to the prior art lies in the fact that either the dispersion of fine and very fine powders does not take place in water, but in organic or organic-aqueous media, or that no passivation of the powders is explicitly achieved in a subsequent dispersion of the cited powders in water. That means that for non-oxidic powders, although an adequate dispersion through the listed auxiliaries in water is described, no protection against oxidation and hydrolysis is described.

The object of the invention is now to propose a method for dispersing and passivating particulate powders in water and aqueous media, with which all the disadvantages of the solutions of the prior art are eliminated. In particular, the object of the invention lies in finding a method for dispersing particulate powders in water with which a passivation against the chemical attack of the water is simultaneously achieved for non-oxidic powders and elemental powders, in addition to the dispersion, and the oxygen content does not thereby increase or increases only slightly compared to the treatment according to the prior art.

The object is attained through the invention disclosed in claim 1. Further developments are the subject matter of claims 2 through 13. In the method according to the invention water-soluble polyvinylamines and/or the initial products thereof, such as, e.g., polyvinyl formamides, are used for dispersing particulate powders in water and/or aqueous media and furthermore for passivating non-oxidic particulate powders in water. Polyvinylamines have the general summation formula —[CH₂—CH—NH₂]ₙ— and in each structural unit have an NH₂-(amine-) group that can be protonated in water. Polyvinyl formamides have the general summation formula —[CH₂—CH—NH—CHO]ₙ— and have an —NH—CHO— (formamide) group that can be protonated in water.

The water-soluble polyvinylamines and/or the initial products thereof used have a molar weight of 5000 to 350,000, preferably 5000 to 100,000. They are used in a concentration of 0.01 to 10% by weight, based on the solids content of the suspension, preferably 0.1 to 0.5% by weight. Primarily hard-metal powders, non-oxidic ceramic powders and/or elemental powders are used as particulate powders. The hard-metal powders used thereby comprise carbides, nitrides and/or carbon nitrides of the elements of the auxiliary groups IV, V and/or VI of the Periodic Table of the Elements (PTE) and Co, Ni and/or Fe. These hard-metal powders can thereby comprise a mixture of WC and/or in part other hard materials, such as TiC, TaC, NbC, Cr₃C₂, VC and Co and/or in part Ni and/or Fe as binder metal and/or a mixture of TiC or TiCN and Mo₂C and Co and/or Ni and/or Fe as binder metal. Nitrides, carbides, borides and/or silicides, such as, e.g., Si₃N₄, SiC, AlN, BN, B₄C, TiN, TiC, ZrC and/or ZrN are used as non-oxidic ceramic powders. Crystalline and/or amorphous elements of the 3^{rd} and 4^{th} main group of the Periodic Table of the Elements (PTE) are used as elemental powders. These include, e.g., elementary boron and silicon and carbon in the form of graphite, diamond powder, carbon blacks and other amorphous and partially crystalline C-modifications.

According to the invention the auxiliary polyvinylamine and/or the initial products thereof are dissolved in the given concentration in water while being stirred and subsequently the particulate powder is added in portions with further stirring and optionally with ultrasonic treatment. Subsequently, a mixed grinding can follow in a ball grinder, e.g., in an agitator ball mill. The solids content of the aqueous suspensions is 40-90% by weight, preferably 60-85% by weight. A suspension that is stable for the time of the further processing is obtained with the polyvinylamine and/or the initial products thereof as auxiliaries and viscosities that are very suitable for spray-drying processes are established. With solids contents of 70% the viscosities are, e.g., in the range of 12-100 mPa*s or with solids contents of 85%, e.g., in the range of 20-300 mPa*s.

With an addition concentration of, e.g., 0.2% by weight polyvinylamine and/or the initial products thereof based on the solids contents, the dynamic mobility, which as a measured variable for the electrostatic repelling powers or for the calculation of the zeta potential describes the stability and dispersibility of the particulate powder particles in the suspension, reaches values of 0.8 to 2 m²(V*s)⁻¹, which represents a multiple of the values that can be achieved with the addition of auxiliaries that suffice in the prior art.

It was found that the described method for dispersing particulate powders with polyvinylamine and the initial products thereof, such as, e.g., polyvinyl foramide as auxiliary with non-oxidic particulate powders and with elemental powders furthermore leads to a passivation of these powders, i.e., to the protection thereof from oxidation and hydrolysis and thus does not lead to an increase or only to a slight increase in the oxygen content compared to treatment according to the prior art. It is assumed that protonated NH₂ groups that are on each structural unit of the polyvinylamine and that do not break the continuous carbon chain as, e.g., with polyethylene imine, are particularly suitable for bringing about an effective protection against the water molecules due to electrostatic and steric interactions with the charge and structural conditions of the powder surface. Through the method according to the invention it is possible to process particulate powders that cannot otherwise be processed in water, such as hard-metal powders, non-oxidic ceramic powders and elemental powders in water in a cost-effective and environmentally compatible manner without their oxygen content rising perceptibly compared to processing according to the prior art. All the disadvantages of the prior art can be eliminated and the objects attained with the solution according to the invention.

The invention is described in more detail below on the basis of exemplary embodiments.

### EXAMPLE 1

An aqueous suspension containing 72% by weight WC/Co powder (thereof 90% by weight WC and 10% by weight Co), is produced by dissolving in water 0.15% by weight polyvinylamine with a molar weight of <10,000 g/mol, based on the solids content of the suspension and subsequently stirring in the hard-metal powder mixture. The WC grain size was 0.5 μm. After 6 h of mixed grinding in an attrition mill, the viscosity was 28 mPa*s, with a shearing rate of 240 min⁻¹. The oxygen content after grinding was 0.38%. The dynamic mobility was 0.9 m²(V*s)⁻¹. Without polyvinylamine as an additive, the oxygen content rose to 0.7%.

### EXAMPLE 2

An aqueous suspension containing 72% by weight hard-metal powder (thereof 59% by weight WC, 16% by weight TiC, 11.2% by weight TaC, 4.8% by weight NbC and 9% by weight Co) is produced by dissolving in water 0.15% by weight polyvinylamine with a molar weight of 45,000 g/mol, based on the solids content of the suspension, and subsequently stirring in the hard-metal powder mixture. After 6 h mixed grinding in an attrition mill, the viscosity was 15 mPa*s, with a shearing rate of 240 min⁻¹. The oxygen content after grinding was 0.54%. The dynamic mobility was 1.2 m²(V*s)⁻¹.

### EXAMPLE 3

An aqueous suspension containing 40% by weight ceramic silicon nitride powder mixture (thereof 90% by weight Si₃N₄, 6% by weight Y₂O₃ and 4% by weight Al₂O₃), is produced by dissolving in water 0.6% by weight polyvinylamine with a molar weight of 45,000 g/mol, based on the solids content of the suspension, and subsequently stirring in the ceramic powder mixture. After 3 h mixed grinding in a laboratory attrition mill, the viscosity was 32 mPa*s, with a shearing rate of 240 min⁻¹. The dynamic mobility was 1.2 m²(V*s)⁻¹. Without the addition of polyvinylamine, the viscosity was 299 mPa*s and the dynamic mobility was −0.9 m²(V*s)⁻¹.

1. Method for dispersing and passivating particulate powders in water and aqueous media, whereby additives are added determined by the process, characterized in that water-soluble polyvinylamines and/or the initial products thereof are used as auxiliaries.

2. Method according to claim 1, characterized in that the polyvinylamines and/or the initial products thereof have a molar weight of 5000 to 350,000.

3. Method according to claim 2, characterized in that polyvinylamines and/or the initial products thereof with a molar mass between 5000 and 100,000 are used.

4. Method according to claim 1, characterized in that the polyvinylamines and/or the initial products thereof are used in a concentration of 0.01 to 10% by weight, based on the solids content of the suspension.

5. Method according to claim 4, characterized in that polyvinylamines and/or the initial products thereof are used in a concentration of 0.1 to 0.5% by weight, based on the solids content of the suspension.

6. Method according to claim 1, characterized in that the polyvinylamines and/or the initial products thereof are dissolved in water while being stirred before the addition of the particulate powders.

7. Method according to claim 1, characterized in that initial products of polyvinylamine are used as auxiliaries.

8. Method according to claim 1, characterized in that polyvinyl formamides are used.

9. Method according to claim 1, characterized in that hard-metal powders, non-oxidic ceramic powders and/or elemental powders are used as particulate powders.

10. Method according to claim 9, characterized in that carbides, nitrides and/or carbon nitrides of the elements of the auxiliary groups IV, V and VI of the PTE (Periodic Table of the Elements) and Fe, Co, Ni individually, mixed or alloyed as powders containing binder metal phase, are used as hard-metal powders.

11. Method according to claim 9, characterized in that nitrides, carbides, borides and/or suicides are used as non-oxidic ceramic powders.

12. Method according to claim 9, characterized in that crystalline and/or amorphous elements of the 3^{rd} and 4^{th} main group of the PTE are used as elemental powders.

13. Method according to claim 1, characterized in that the oxygen content of non-oxidic particulate powders such as hard-metal, ceramic and elemental powders used is not increased or is increased only slightly.
